(19) United States
(12) Patent Application Publication
(10) Pub. No.: US 2026/0340459 A1
(43) Pub. Date: Oct. 29, 2026

(54) Real-Time Sales Intelligence and Deal Recommendation System Using Temporal Knowledge Graphs and Reinforcement Learning

(71) Applicants: Curtis De Jazwiecki, Maumee, OH (US); David Irvine, Dubai (AE); Bao Tran, Saratoga, CA (US)

(72) Inventors: Curtis De Jazwiecki, Maumee, OH (US); David Irvine, Dubai (AE); Bao Tran, Saratoga, CA (US)

(21) Appl. No.: 19/190,354

(22) Filed: Apr. 25, 2025

(51) Int. Cl. G06N 5/047; G06N 5/022; G06Q 30/0202

(52) U.S. Cl. CPC G06N 5/047; G06N 5/022; G06Q 30/0202

(57) ABSTRACT

A method collects heterogeneous sales-related data from sources such as CRM systems, communication platforms, quoting systems, inventory databases, and marketing tools to continuously construct a temporal knowledge graph, known as the Deal Memory Graph. This graph is built by performing entity resolution and inferring both explicit and implicit relationships among customers, products, and interactions using techniques like graph neural networks and transformer-based cross-dataset matching. Real-time graph analytics, which include temporal pattern detection, cross-modal attention, and reinforcement learning, identify sales patterns, customer preferences, and key engagement signals during active interactions. Based on this analysis, the system generates personalized, context-aware prompts and actionable suggestions—such as recommended talking points, objection handling strategies, and follow-up content—that are tailored to individual sales representative behaviors and prospect characteristics. The system continuously refines its outcomes by updating the Deal Memory Graph, improving AI models through feedback, and incorporating market signals, competitor activities, and synthetic stress testing, while employing graph motif extraction, few-shot learning, and differential privacy-preserving updates to maintain adaptive, compliant, and energy-efficient operations for both immediate guidance and long-term sales pipeline management.

This application is related to co-pending serial application Ser. No. 19/190,346 filed Apr. 25, 2025, the content of which is incorporated by reference.

### BACKGROUND OF THE INVENTION

In today's competitive market landscape, organizations are increasingly challenged by the need to efficiently process and interpret vast streams of sales data to respond to rapidly evolving customer demands and market dynamics. Traditional sales intelligence methods, while foundational, often fall short in delivering timely insights due to their limited capacity to integrate historical data with ongoing transactional trends. The growing adoption of data-driven technologies and advanced analytics has led to innovative approaches that strive to bridge this gap, emphasizing the importance of integrating real-time data processing with historical performance records. This evolution in sales intelligence reflects the broader movement toward more adaptive and responsive decision-making tools capable of navigating complex, temporally dynamic business environments.

### SUMMARY OF THE INVENTION

In one aspect, a method includes collecting sales-related data from multiple sources such as a CRM system, communication platforms, quoting systems, inventory databases, and marketing tools using a sales intelligence system. The method further involves generating a Deal Memory Graph that associates and stores data representing customer interactions across these various sources. An artificial intelligence engine then analyzes the Deal Memory Graph to identify sales patterns, customer preferences, and engagement signals in real time. Based on this analysis, the system provides real-time prompts and actionable suggestions to sales representatives during customer interactions. Finally, the method personalizes these prompts and suggestions according to predefined behavioral modes and brand tone profiles for individual sales representatives and updates the Deal Memory Graph along with the AI models based on the outcomes of sales interactions to continuously improve future recommendations.

In a further aspect, the method continuously ingests heterogeneous data streams from CRM systems, communication platforms (including email, voice, and chat systems), product configurators, support ticketing systems, and transaction databases. In a further aspect, the method constructs a temporal knowledge graph by performing entity resolution across these diverse data sources using matching algorithms, dynamically inferring relationships between deal entities with graph neural networks, and generating unified contextual embeddings from multi-modal data such as text, audio, and structured inputs. In a further aspect, the method performs real-time graph analytics by detecting temporal patterns across deal lifecycle stages, implementing cross-modal attention mechanisms to identify critical relationship pathways, and utilizing reinforcement learning models to optimize next-best-action recommendations. In a further aspect, the method generates contextual interventions by automatically synthesizing deal-specific playbooks from historical success patterns, providing real-time conversation guidance, and calculating predictive risk scores for deal trajectories.

Advantages of one implementation may include one or more of the following:
Real-time Insights: The system continuously integrates heterogeneous data streams—from CRM systems to communication channels—to provide up-to-the-moment intelligence that aids sales representatives in making informed decisions during customer interactions.
Enhanced Decision-Making: By generating a Deal Memory Graph and performing entity resolution across multiple data sources, one implementation creates a holistic view of customer interactions and sales patterns, enabling the delivery of contextual, data-driven recommendations.
Personalization and Adaptability: The method personalizes actionable prompts based on predefined behavioral modes and brand tone profiles for individual sales representatives, enhancing the relevance and effectiveness of engagement strategies.
Dynamic Learning and Improvement: Incorporating artificial intelligence and reinforcement learning models allows the system to continuously update and refine its recommendations based on the outcomes of past interactions, ensuring that the learning curve adapts to evolving sales dynamics.
Comprehensive Data Fusion: One implementation is capable of amalgamating structured, semi-structured, and unstructured data—including text, audio, and other multi-modal inputs—into unified contextual embeddings, dramatically improving the accuracy of pattern detection and relationship inference.
Improved Engagement and Risk Management: The system's ability to analyze temporal patterns and generate predictive risk scores for deal trajectories empowers organizations to proactively manage deal risks, optimize follow-up strategies, and ultimately enhance customer engagement.
Scalability and Flexibility: Designed to handle data from diverse channels and platforms, the method supports scalable deployment, making it suitable for organizations of varying sizes and sectors facing complex, data-rich sales environments.

These advantages collectively contribute to a robust, adaptive sales intelligence system that improves the efficiency of sales operations, enhances customer interactions, and drives overall business success.

### BRIEF DESCRIPTION OF DRAWINGS

FIG. 1 shows a flowchart illustrating the process of a sales intelligence system, including data collection, generating a deal memory graph, analysis by AI, providing real-time prompts, personalizing suggestions, and updating models.

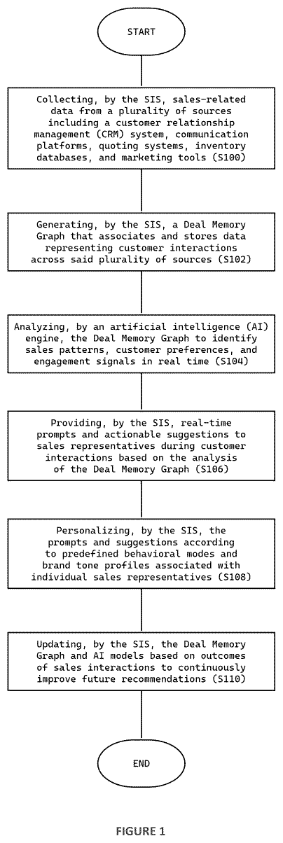

FIG. 2 shows flowchart depicting a process for real-time sales intelligence and deal recommendation using temporal knowledge graphs and reinforcement learning.

### DETAILED DESCRIPTION OF THE INVENTION

One implementation employs a Sales Intelligence System (SIS) that collects sales-related data from a plurality of sources. In one embodiment, the SIS obtains data from customer relationship management systems, communication platforms, quoting systems, inventory databases, and marketing tools as illustrated by the reference sign S100. This comprehensive data collection provides a robust foundation for the subsequent processing and analysis procedures performed by one implementation.

One implementation relates to a system for processing sales-related data by integrating information from a variety of sources and converting it into actionable insights via an advanced analytical framework. The system gathers data from customer relationship management systems, communication platforms, quoting systems, inventory databases, and marketing tools, among others. An artificial intelligence engine processes the unified data to identify key sales patterns, detect customer preferences, and determine engagement signals in real time. This procedure enables the system to provide tailored prompts and actionable suggestions to sales representatives during customer interactions, thus enhancing the efficiency of the sales process. Additionally, the system continuously ingests further heterogeneous data streams and applies techniques such as entity resolution, graph neural networks, and reinforcement learning to construct dynamic representations and refine next-best-action recommendations.

In one embodiment, the system generates a Deal Memory Graph that associates and stores data representing customer interactions across the plurality of sources (S102). In this embodiment, the sales intelligence system generates the Deal Memory Graph by organizing and storing data obtained from diverse sources into a unified graph structure. This graph not only preserves the relational connections among data points corresponding to customer interactions but also provides a framework for real-time analytics. By maintaining and continuously updating this graph, the system enhances its ability to track the evolution of sales interactions and improve predictive recommendations based on the aggregated historical and contextual data.

An artificial intelligence engine continually processes data from a Deal Memory Graph to identify evolving sales trends, assess customer preferences, and detect engagement signals as they emerge. In one embodiment, the engine uses advanced machine learning models to conduct real-time analysis of multi-modal data inputs collected from various sources, as described in S104. This approach allows for the dynamic detection of trends and behavioral indicators that guide subsequent sales actions. By systematically examining the structure of the Deal Memory Graph, the engine correlates diverse data points and reveals key relationships, ensuring that actionable insights are promptly delivered during customer interactions.

The system is configured to provide real-time prompts and actionable suggestions to sales representatives during their interactions with customers. By continuously analyzing the Deal Memory Graph through an artificial intelligence engine, the SIS identifies patterns and signals derived from the aggregated customer interaction data, thereby enabling the delivery of precise recommendations when they are most needed. In this embodiment, the SIS generates prompts that offer contextual guidance to sales representatives during live customer conversations, ensuring that the insights derived from the analysis are immediately applicable. The system is designed to streamline the interaction process by furnishing actionable insights that support efficient decision making and enhance customer engagement. This functionality is referenced herein as S106.

The system is configured to tailor the real-time guidance it provides in accordance with individual sales representative profiles. In this approach, predefined behavioral modes and brand tone profiles that have been established for each representative are taken into account to adapt both the prompts and actionable suggestions. Specifically, as described in reference label S108, personalization is achieved by matching the contextual intelligence derived from multiple heterogeneous data streams with these unique profiles. This ensures that the system's recommendations are not only timely but also closely aligned with the distinct communication style and professional demeanor of each sales representative, thereby supporting enhanced customer interactions and driving more effective sales engagements.

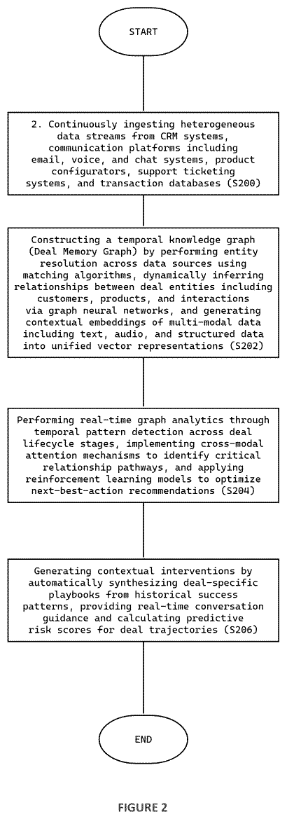

FIG. 2 illustrates a flowchart depicting a process for real-time sales intelligence and deal recommendation. It uses temporal knowledge graphs and reinforcement learning. The flowchart begins with continuous ingestion of heterogeneous data streams from various systems such as CRM and communication platforms. This data feeds into the construction of a temporal knowledge graph, which utilizes entity resolution and graph neural networks to infer relationships between deal entities. Real-time graph analytics are performed to detect temporal patterns and optimize recommendations using reinforcement learning models. Finally, contextual interventions are generated by synthesizing deal-specific playbooks, providing real-time guidance, and calculating predictive risk scores for deal trajectories.

The process entails continuously ingesting diverse data streams from various systems, such as customer relationship management (CRM) platforms, communication tools including email, voice, and chat systems, and product configurators. Additionally, the method incorporates data from support ticketing systems and transaction databases. This data ingestion forms a foundational step to enable real-time sales intelligence by delivering comprehensive and up-to-date information that supports effective decision-making within sales processes.

In this embodiment, constructing a temporal knowledge graph—referred to as a Deal Memory Graph—involves performing entity resolution across diverse data sources using matching algorithms. This process enables the dynamic inference of relationships among deal entities, including customers, products, and interactions, by utilizing graph neural networks. Additionally, the method generates contextual embeddings from multi-modal data, such as text, audio, and structured inputs, transforming them into unified vector representations. This step is integral to integrating and contextualizing varied data streams into a cohesive and analyzable format, as indicated by reference label S202.

The method involves executing real-time graph analytics by detecting temporal patterns across various stages in a deal's lifecycle. It leverages cross-modal attention mechanisms to identify meaningful relationship pathways. Furthermore, the method employs reinforcement learning models to optimize recommendations for subsequent actions.

In the described method, generating contextual interventions involves automatically creating deal-specific playbooks based on patterns of historical success. These playbooks offer real-time conversation guidance tailored to specific sales scenarios. Additionally, predictive risk scores for deal trajectories are calculated to assess the likelihood of successful closure. This step is central to enhancing sales strategies by leveraging past successes to inform current interactions and decisions.

The Deal Memory Graph further includes temporal relationships between customer interactions to enable the identification of sales cycle stages. In this context, temporal relationships refer to the ordering and timing of interactions that allow segmentation of the customer journey into distinct stages such as initial engagement, qualification, proposal, negotiation, and closing. By analyzing these temporal markers, the system identifies transitions between different stages of the sales cycle and detects patterns, such as periods of increased engagement or delays that indicate potential bottlenecks or opportunities for intervention.

The incorporation of temporal relationships facilitates the determination of key milestones in the evolving deal lifecycle, which are then used to calibrate predictive analytics models that forecast deal outcomes. These models utilize machine learning techniques, including graph neural networks, to dynamically infer the significance of temporal patterns and update the Deal Memory Graph accordingly. Additionally, the system leverages reinforcement learning and cross-modal attention mechanisms, using the temporal structure of the data to optimize real-time recommendations provided to sales representatives.

The actionable insights derived from the analysis of the temporally enriched Deal Memory Graph assist in devising subsequent interactions and tailoring conversational strategies, thereby improving the overall efficiency and effectiveness of sales processes. Continuous updating of the Deal Memory Graph based on new interaction data ensures that both historical trends and emerging patterns are captured, allowing for adaptive modulation of the sales strategy in response to dynamic market conditions and customer behavior.

For instance, the supervised learning algorithms use classification or regression techniques to predict the likelihood of a sale based on historical success metrics, while the unsupervised approaches employ clustering or density estimation methods to flag deviations from normally occurring sales patterns. The AI engine integrates outputs from both analyses to generate a comprehensive understanding of established and emerging trends within sales interactions. This dual approach empowers the system to recommend real-time prompts and actionable suggestions tailored to recognized success patterns while simultaneously alerting sales representatives to anomalous activities that require further investigation.

Furthermore, the machine learning models are continuously updated based on feedback derived from the outcomes of sales interactions, thereby refining predictions and adapting to evolving sales strategies and market dynamics over time.

The SIS continuously ingests data streams from multiple sources in real time through an architecture distributed across several processing nodes. The streaming framework uses parallel data ingestion pipelines that concurrently process incoming information, thereby reducing latency by ensuring that data is captured and made available for subsequent processing without delay. Each node within the system incorporates mechanisms to verify the integrity and ordering of incoming data, which ensures consistency across the distributed network. Real-time integration is achieved via event-driven processing techniques whereby each data event is immediately dispatched to processing modules that perform necessary validations, transformations, and enrichment operations before being merged into the central data repository. The distributed streaming design further benefits from fault tolerance capabilities; if a node or process fails, data can be rerouted or reprocessed by other nodes in the network to prevent data loss and maintain system robustness. The use of distributed commit protocols and synchronization mechanisms ensures that all nodes operate together to provide a unified and consistent view of the data while supporting efficient throughput and minimal processing delay. Additionally, the SIS continuously monitors performance parameters and dynamically adjusts resource allocation to handle variations in data volume, thereby ensuring that both integration speed and data accuracy remain optimal even under varying load conditions.

In one embodiment, the SIS incorporates a natural language processing (NLP) component configured to automatically analyze conversation context, sentiment, and engagement signals from both voice and text data. The NLP component processes captured voice data by converting audio inputs into text, thereby enabling subsequent semantic and syntactic analyses. It parses the conversation content to determine contextual relevance, identifying key phrases, entities, and dialogue structures that indicate the progression of customer interactions. The system further employs sentiment analysis techniques, utilizing algorithms that evaluate both textual cues and voice tone inflections to quantify emotional states, detect nuanced sentiment variations, and discern levels of customer engagement. In addition, the NLP component leverages machine learning models that dynamically update their understanding based on historical interaction data and real-time conversation inputs. These models are designed to recognize shifts in conversation dynamics and adjust the significance of engagement signals accordingly. By integrating insights from the analyzed conversation context and sentiment indicators, the SIS is able to generate timely, context-aware prompts for sales representatives. Such prompts provide actionable suggestions that are tailored to the prevailing interaction conditions, thereby optimizing customer engagement during each sales encounter. The approach enables the SIS to continuously refine its analysis and recommendation processes, ensuring that the system evolves in response to changing patterns in customer behavior and conversation subtleties.

The SIS is configured to construct a multi-dimensional prospect profile that aggregates demographic data, behavioral patterns, and communication preferences to generate personalized recommendations for sales interactions. The prospect profile is formulated by collecting demographic information such as age, gender, geographic location, occupation, and income level from various data sources, including CRM systems and public records, and by incorporating behavioral data such as past purchase history, engagement metrics from digital channels, and historical interaction logs. Additionally, communication preferences concerning preferred channels—for example, email, phone, or messaging platforms—and optimal contact times are integrated into the profile. The system continuously updates this profile in real time based on incoming data streams and outcomes of previous interactions, thereby ensuring that the prospect profile reflects the most current and relevant customer information. Using advanced machine learning algorithms, the SIS analyzes the prospect profile to detect patterns and predict customer responses, dynamically adjusting the recommendations to match the prospect's current state and communication preferences. The multi-dimensional aspect of the prospect profile allows the SIS to deliver highly tailored conversation guidance and next-best-action recommendations to the sales representative, thereby optimizing engagement by aligning suggested interactions with the prospect's unique characteristics. This implementation of a dynamic and comprehensive prospect profile ensures that recommendations are not only contextually relevant but also adapt to evolving customer behaviors over time.

The SIS dynamically prioritizes sales pipeline opportunities by evaluating multiple attributes in real time. In embodiments, the SIS collects sales-related data from various sources such as customer relationship management systems, communication platforms, quoting systems, inventory databases, and marketing tools to obtain comprehensive deal information. The system then assesses the deal size by determining the monetary value or potential revenue associated with each sales opportunity. In addition, the SIS calculates a win probability for an opportunity by analyzing historical sales data, customer interactions, and other predictive indicators stored within the Deal Memory Graph. The resource availability is also considered by evaluating the current capacity and readiness of sales personnel and other necessary resources required to support a given opportunity. To integrate these factors, the SIS employs a dynamic scoring algorithm that assigns weighted values to deal size, win probability, and resource availability, thereby generating a composite prioritization metric. This metric is continuously updated as new data is ingested and as past sales interactions are analyzed, allowing the SIS to adapt to evolving market conditions and resource allocations. In some embodiments, the SIS further refines the prioritization process using reinforcement learning models and real-time graph analytics to capture temporal patterns and adjust to shifting deal characteristics. The resulting prioritized list of sales pipeline opportunities enables sales representatives to focus on those opportunities most likely to convert while optimally aligning available resources to achieve the highest overall sales impact.

In one embodiment, the SIS integrates with external data sources to process market signals, news feeds, and competitor activities for real-time market intelligence, wherein the SIS concurrently collects sales-related data from a plurality of sources, including a customer relationship management (CRM) system, communication platforms, quoting systems, inventory databases, and marketing tools as disclosed in S100. The system further generates a Deal Memory Graph (S102) that associates and stores data representing customer interactions across these diverse sources, and is enhanced by incorporating external market intelligence data. The acquired external data, including real-time market signals, news feeds, and competitor activities, is processed to augment the Deal Memory Graph, thereby enabling the synthesis of a more robust and context-rich representation of deal dynamics.

In one embodiment, the SIS utilizes entity recognition and relationship extraction algorithms to identify market-relevant entities and their interconnections from a wide variety of structured and unstructured data sources. The system applies natural language processing techniques to detect and classify particular keywords, phrases, and patterns associated with market dynamics such as product identifiers, competitor names, consumer segments, geographic regions, and economic indicators. The entity recognition algorithms are configured to parse data streams from sources including transactional records, social media feeds, news articles, and internal reports, thereby ensuring comprehensive coverage of market information.

Simultaneously, the relationship extraction algorithms analyze co-occurrence patterns, syntactic dependencies, and contextual cues to determine the relationships among the identified entities. These relationships encompass correlations that reflect supply and demand trends, competitive interactions, and evolving consumer preferences. The output of the relationship extraction stage is used to establish and continuously update a knowledge graph in which nodes represent market entities and edges represent the inferred relationships between these entities.

The evolving knowledge graph of market dynamics is maintained by integrating newly identified entities and relationships with previously stored information, allowing the graph to adapt over time as new data is ingested. The SIS periodically or continuously re-evaluates the graph structure based on emerging patterns and revised confidence levels, ensuring that the knowledge graph remains an accurate and current representation of market dynamics. In some embodiments, the system employs machine learning techniques, such as deep neural networks or transformer-based models, to enhance the precision of entity recognition and relationship extraction, thereby improving the overall quality and relevance of the resulting knowledge graph.

A computer-implemented method is provided, wherein a computer system continuously ingests heterogeneous data streams from CRM systems, communication platforms including email, voice, and chat systems, product configurators, support ticketing systems, and transaction databases. The system processes the ingested data to extract relevant sales-related information, which is then subjected to an entity resolution process. During this process, matching algorithms are applied to reconcile and merge data from different sources, enabling the identification of deal entities such as customers, products, and interactions. Graph neural networks are employed to dynamically infer relationships between these entities, thereby facilitating the construction of a temporal knowledge graph, referred to as the Deal Memory Graph. In addition, the method generates contextual embeddings of multi-modal data including text, audio, and structured data, integrating these into unified vector representations that serve as the basis for further analysis.

Entity resolution is performed using a transformer-based cross-dataset matching approach that leverages multi-layer attention mechanisms to weight domain-specific features from each data source. In embodiments, input data streams from various systems are processed through transformer encoders that generate contextual embeddings, thereby preserving semantic information inherent in the data. The attention mechanism is configured to emphasize the most relevant features based on the operational domain, enabling accurate matching and aggregation of diverse data elements. The transformer architecture is trained with objectives that align the representation of heterogeneous data, which facilitates the integration of multi-modal information from structured and unstructured sources.

Relationship inference is performed by integrating explicit relationships from structured data with implicit relationships derived from data analysis techniques. Explicit relationships are established using property graph semantics, where nodes representing entities such as customers, products, and interactions are connected based on defined properties and relationships extracted from the structured data. In parallel, implicit relationships are deduced through temporal co-occurrence analysis that identifies patterns in the timing of interactions, semantic similarity clustering that groups entities based on proximity in embedding space, and causal inference methods that analyze historical deal outcomes to determine the impact and likelihood of future interactions. This combined approach enables the seamless integration of deterministic and probabilistic signals, resulting in a comprehensive mapping of relationships within the Deal Memory Graph that enhances real-time analysis and recommendation accuracy.

In one embodiment, the system constructs contextual embeddings from multi-modal data including sales conversation transcripts, product documentation, support ticket histories, deal progression data, customer sentiment trajectories, and pricing negotiation records. The contextual embeddings are optimized through contrastive learning objectives designed to align semantically related information across these varied data sources. For instance, sales conversation transcripts are encoded into a latent vector space and aligned with representations derived from product documentation, ensuring that similar themes and topics are closely correlated. Similarly, historical support ticket records are contrasted and aligned with patterns observed in deal progression data, thereby enabling the system to identify underlying support issues that impact the trajectory of a deal. Additionally, customer sentiment trajectories—extracted through analysis of real-time engagement signals and emotional cues—are aligned using the same contrastive framework with information representative of pricing negotiations. This alignment of customer sentiment with pricing dynamics facilitates more accurate assessments of customer responses during price-related discussions. The contrastive learning approach employs methods such as a contrastive loss function that minimizes the distance between embeddings of related data pairs while maximizing the distance between unrelated pairs, thereby enhancing the discriminative power of the representation. The refined embeddings resulting from this process are utilized by the SIS to perform subsequent real-time graph analytics and to generate actionable, contextually appropriate recommendations during sales interactions. In some embodiments, the contrastive learning objectives are integrated within an end-to-end training schema that iteratively refines both the embeddings and associated AI models based on continuous feedback from sales outcomes, thereby contributing to greater accuracy in next-best-action suggestions and overall system performance.

A system is provided that employs a hybrid graph storage architecture to support efficient and scalable management of a dynamic graph representing sales interactions and deal entities. In embodiments, the architecture comprises an online transaction processing (OLTP)-optimized property graph database that enables real-time updates of nodes, edges, and associated properties as new data is collected from various sources. Simultaneously, a distributed graph online analytical processing (OLAP) engine is employed to perform complex analytical queries across large volumes of historical data, thereby facilitating the identification of trends and patterns throughout the deal lifecycle. Complementing these components, a compressed in-memory graph cache is utilized to enable rapid traversal of frequently accessed data, thereby reducing query response times and ensuring prompt access to essential information during time-sensitive sales interactions.

In further aspects, the system implements continuous graph evolution by supporting automated schema extension for new data types introduced over time. This mechanism leverages few-shot learning techniques to generalize from a limited set of labeled examples in order to automatically adapt the graph schema through the addition of nodes, edges, or attributes corresponding to emerging data categories without necessitating extensive manual intervention. In addition, the system optimizes graph connectivity patterns by employing multi-agent reinforcement learning. Multiple reinforcement learning agents interact within a simulated environment to determine optimal connectivity strategies, thereby dynamically adjusting relationships between deal entities to maximize relevance and accuracy. Finally, differential privacy-preserving updates are applied based on a closed-loop feedback system that monitors system performance and user interactions, ensuring that modifications to the graph retain data privacy while maintaining utility and accuracy.

Additional embodiments include the use of cross-modal attention techniques via heterogeneous graph transformers. These transformers manage interactions between nodes and edges by accommodating the diverse types and modalities of data elements. Dynamic attention weighting is applied based on contextual factors such as the stage of the deal phase and the specific role of the user interacting with the system, thereby directing the analysis toward areas of highest potential impact. Furthermore, explainability heatmaps are produced to visually emphasize significant sub-structures within the graph, allowing users and analysts to grasp the key relationships and the underlying decision-making processes of the system.

In further detail, reinforcement learning models within the system employ graph-based state representations derived from techniques resembling node2vec-style embeddings. These embeddings capture the inherent structural information of the graph by mapping nodes into a vector space where proximity reflects similarity and connectivity. The reinforcement learning framework is guided by reward functions designed to balance immediate conversion objectives with enduring relationship value. Accordingly, the system conducts multi-objective optimization across several metrics including revenue generation, profit margin, and customer satisfaction. By simultaneously considering these objectives, the reinforcement learning models are enabled to recommend next-best actions and interventions that are optimal for both immediate performance and sustained growth over time.

Through the integration of the hybrid graph storage architecture, automated schema evolution, cross-modal attention mechanisms, and reinforcement learning models employing graph-based state representations, the disclosed system delivers a robust and adaptive solution for managing and optimizing complex sales interactions and deal trajectories.

In one embodiment, automated playbook synthesis is achieved by combining graph motif extraction, few-shot template generation using large language models, and compliance-aware content filtering based on regulatory graphs. In this embodiment, the system first analyzes the Deal Memory Graph to extract recurring graph motifs indicative of successful deal patterns. The graph motif extraction module identifies subgraph structures and connections among entities that consistently correspond to favorable sales outcomes, thereby isolating key success factors embedded within historical data. These extracted motifs serve as foundational elements for playbook synthesis. Concurrently, the system employs a few-shot template generation approach that leverages large language models. In this process, the system provides minimal yet descriptive training examples representing successful playbook textual formats and narrative styles, allowing the language model to generate candidate playbook templates that capture the strategic advice and actions pertinent to specific deal contexts. The generated templates are then analyzed in the context of compliance requirements. Compliance-aware content filtering is implemented by referencing regulatory graphs that codify guidelines, industry standards, and internal policies relevant to the deal processes. The regulatory graphs enable the system to automatically filter out any content or language in the synthesized playbooks that conflict with prescribed regulatory frameworks. As a result, the final playbook synthesis integrates data-driven insights from graph motif extractions, coherent narrative structures generated through few-shot learning, and adherence to compliance mandates dictated by the regulatory graphs, ensuring that the resultant playbooks provide actionable, contextually relevant, and regulation-compliant guidance for sales representatives.

The present disclosure provides a method comprising implementing real-time conversation guidance that incorporates streaming graph queries to continuously monitor incoming data streams and detect specific conversation triggers. In this implementation, the system dynamically evaluates ongoing customer interactions by processing streaming data through a graph query framework, which identifies events or patterns that warrant immediate attention. Following the detection of such triggers, contextual suggestions are ranked using learned policy networks that are trained on historical interaction data to predict the most pertinent recommendations. The method further includes an optimization process that adjusts the recommendation acceptance rates based on feedback metrics and evolving interaction contexts so as to refine the guidance provided to sales representatives.

In another embodiment, the method further comprises performing predictive risk scoring by employing graph isomorphism networks that compare the structure and attributes of a current deal graph to those of historical failures. This comparison is enhanced by applying dynamic centrality analysis, which is used to identify fragile dependencies between customer and product nodes or other entities within the graph. Additionally, the method utilizes counterfactual reasoning to evaluate alternative graph trajectories, thereby offering a risk score that reflects not only the current state of the deal but also the potential outcomes if alternative interaction strategies are pursued.

In additional aspects, cross-deal knowledge transfer is achieved by incorporating meta-learning techniques that extract and transfer graph patterns observed across different industries and deal types. This approach is supplemented by employing adversarial domain adaptation methods, which facilitate the adjustment of models between vertical markets with distinct characteristics. Furthermore, graph prompt engineering is utilized to enable few-shot learning, allowing the system to generalize from a limited set of labeled examples while maintaining robust accuracy in suggesting actionable recommendations.

Continuous validation of the graph-based system is also an integral component of the method. The system generates synthetic deal graphs automatically to simulate a wide variety of stress testing conditions and to validate the robustness of the graph analytics. In parallel, the method incorporates concept drift detection mechanisms to monitor shifts in relationship patterns over time, ensuring the system remains current with the evolving data. An A/B testing framework is further integrated to systematically evaluate and compare different graph update strategies, allowing for iterative improvements and the adoption of the most effective methodologies.

The method further incorporates energy-efficient graph processing through a combination of advanced techniques. A sparsity-aware neural architecture search is performed to identify optimized embedding models that balance computational load with system performance. Additionally, dynamic computation graph pruning techniques are applied to eliminate redundant calculations and reduce processing time, while hardware-aware quantization of graph parameters is employed to tailor the system's capabilities to the available computing resources. In combination, these techniques contribute to a reduction in energy consumption while maintaining robust operation in real-time graph analytics and recommendation computations.

1. A method for providing recommendations with a sales intelligence system (SIS), comprising:
collecting, by the SIS, sales-related data from a plurality of sources including a customer relationship management (CRM) system, communication platforms, quoting systems, inventory databases, and marketing tools;
generating, by the SIS, a Deal Memory Graph that associates and stores data representing customer interactions across said plurality of sources;
analyzing, by an artificial intelligence (AI) engine, the Deal Memory Graph to identify sales patterns, customer preferences, and engagement signals in real time;
providing, by the SIS, real-time prompts and actionable suggestions to sales representatives during customer interactions based on the analysis of the Deal Memory Graph;
personalizing, by the SIS, the prompts and suggestions according to predefined behavioral modes and brand tone profiles associated with individual sales representatives;
updating, by the SIS, the Deal Memory Graph and AI models based on outcomes of sales interactions to continuously improve future recommendations.

2. The method of claim 1, wherein the Deal Memory Graph further comprises temporal relationships between customer interactions to enable identification of sales cycle stages.

3. The method of claim 1, wherein the AI engine employs both supervised and unsupervised machine learning models to recognize historical sales success patterns and detect anomalies in sales processes.

4. The method of claim 1, wherein the SIS integrates data streams in real time using a distributed streaming architecture to ensure low latency and data consistency.

5. The method of claim 1, wherein the actionable suggestions include recommended talking points, objection handling strategies, or case studies relevant to the ongoing customer interaction.

6. The method of claim 1, wherein the SIS utilizes natural language processing to analyze conversation context, sentiment, and engagement signals from voice and text data.

7. The method of claim 1, wherein the SIS maintains a continuous learning loop by capturing explicit and implicit feedback from sales representatives and updating AI models accordingly.

8. The method of claim 1, wherein the prompts and suggestions are delivered via a context-aware mechanism that determines optimal timing for surfacing insights to sales representatives.

9. The method of claim 1, wherein the SIS employs a multi-dimensional prospect profile combining demographic data, behavioral patterns, and communication preferences to personalize recommendations.

10. The method of claim 1, wherein the SIS identifies cross-selling opportunities by analyzing product usage patterns and mapping relationships between product lines and customer needs.

11. The method of claim 1, wherein the SIS predicts optimal engagement timing by analyzing historical interaction data and real-time behavioral signals to maximize response probability.

12. The method of claim 1, wherein the SIS dynamically prioritizes sales pipeline opportunities based on deal size, win probability, and resource availability.

13. The method of claim 1, wherein the Deal Memory Graph™ is implemented as a temporal graph database structure enabling pattern matching across sales activities and outcomes.

14. The method of claim 1, wherein the SIS provides automated follow-up recommendations by determining optimal timing and content for sales communications using natural language generation.

15. The method of claim 1, wherein the SIS identifies which sales actions most strongly influence successful deal closure.

16. The method of claim 1, wherein the SIS integrates with external data sources to process market signals, news feeds, and competitor activities for real-time market intelligence.

17. The method of claim 1, wherein the SIS utilizes entity recognition and relationship extraction algorithms to maintain an evolving knowledge graph of market dynamics.

18. The method of claim 1, wherein the SIS provides real-time conversation guidance by analyzing ongoing sales interactions and suggesting contextually relevant talking points.

19. The method of claim 1, wherein the SIS automatically generates personalized outreach content for each prospect based on their profile and interaction history.

20. The method of claim 1, wherein the SIS continuously updates the Deal Memory Graph and recommendation models based on the outcomes of sales interactions, including deal closures and customer feedback.

21. A computer-implemented method, comprising:
2. Continuously ingesting heterogeneous data streams from CRM systems, communication platforms including email, voice, and chat systems, product configurators, support ticketing systems, and transaction databases;
constructing a temporal knowledge graph (Deal Memory Graph) by performing entity resolution across data sources using matching algorithms, dynamically inferring relationships between deal entities including customers, products, and interactions via graph neural networks, and generating contextual embeddings of multi-modal data including text, audio, and structured data into unified vector representations;
performing real-time graph analytics through temporal pattern detection across deal lifecycle stages, implementing cross-modal attention mechanisms to identify critical relationship pathways, and applying reinforcement learning models to optimize next-best-action recommendations;
generating contextual interventions by automatically synthesizing deal-specific playbooks from historical success patterns, providing real-time conversation guidance and calculating predictive risk scores for deal trajectories.
